(19) United States
(12) Patent Application Publication
(10) Pub. No.: US 2025/0129771 A1
(43) Pub. Date: Apr. 24, 2025

(54) Rotary Inertia Drive

(71) Applicant: David Roger Rastall, De Pere, WI (US)

(72) Inventor: David Roger Rastall, De Pere, WI (US)

(21) Appl. No.: 18/919,731

(22) Filed: Oct. 18, 2024

Related U.S. Application Data
(60) Provisional application No. 63/591,132, filed on Oct. 18, 2023.

(51) Int. Cl. F03G 3/08

(52) U.S. Cl. CPC F03G 3/083

(57) ABSTRACT

An inertia drive apparatus includes an indexing drive element and a driveshaft coupled to the indexing drive element, the driveshaft having a linear configuration that is rotated when the indexing drive element is actuated. A rotary shaft is coupled to the driveshaft via a coupling. The apparatus includes a plurality of spindles each having a proximal end coupled to the rotary shaft and extending away. At least one flyweight is slidably coupled to each spindle shaft and configured to rotate and slide outwardly when actuated and accelerating and to slide inwardly when decelerating. The outward movement upon each spindle shaft and impact with a respective stopper causes a tinsile force to be induced in each respective spindle shaft and then to be transferred to the rotary shaft whereby to cause propulsion of the inertial drive apparatus.

### REFERENCE TO RELATED APPLICATIONS

This is a non-provisional patent application claiming the priority of provisional application 63/591,132 filed Oct. 18, 2023 titled Rotary Inertia Drive and which is incorporated herein by reference in its entirety.

### FIELD OF THE INVENTION

The present invention relates to the driving of vehicles, equipment or other bodies by using only inertial force. A particular body can be driven without contact from wheels, gears or other external drivers contacting the body and without employing a reaction drive used such as rocket or jet propulsion. The inertial drive would be carried within the driven body.

### BACKGROUND OF THE INVENTION

There are a number of difficulties that are encountered when driving a body through a fluid or a vacuum when the drive has to contact the medium through which it passes. A propulsive force can only be generated when travelling through a fluid, typically air or water, by means of propeller or paddle wheel. These mechanisms turbulate the fluid and have to rely on fluid pressure to operate. They become quite “noisy” and fail at high speeds due to the breakdown of the fluids into their component elements. They also fail at low fluid densities like those encountered at high altitudes. In a vacuum only, reaction drives operate and they are hard to control and can only travel as fast as they expel matter from their exhaust.

A need exists to generate forces in a vacuum for space travel. Conventional rocket engines have a velocity limitation of under 100,000 miles per hour. An inertia drive could theoretically reach the speed of light. This would greatly facilitate deep space travel. Also, small inertia drives could be attached to equipment or people to simulate gravity for purposes of space travel, positional stability, and to help slow the effects of gravity depravation on the human body. A benefit of an inertia drive is that it does not require oxygen to operate. Therefore, a spacecraft, or high-altitude aircraft could be powered electrically and use solar energy or a totally enclosed nuclear reactor. An inertia drive could also be used in confined places where driving a body with a complex mechanism is not possible such as opening and closing a sliding door.

### SUMMARY OF THE INVENTION

An inertia drive apparatus according to the present invention includes an indexing drive element and a driveshaft coupled to the indexing drive element, the driveshaft having a linear configuration that is rotated when the indexing drive element is actuated. A rotary shaft is coupled to the driveshaft via a coupling such that said shaft portions are configured to rotate at a consistent speed. In other words, an increase in rotational speed of the rotary shaft will influence the rotational speed of the driveshaft and vice versa.

In another aspect, the apparatus includes a plurality of spindle shafts each having a proximal end coupled to the rotary shaft and extending away. At least one flyweight is slidably coupled to each spindle shaft and configured to rotate (i.e., to spin or revolve around an imaginary longitudinal axis defined by the respective spindle shaft and to slide outwardly on the respective spindle shaft when actuated and accelerating and to slide inwardly when decelerating). This movement upon each spindle shaft causes a force to be induced in each respective spindle shaft and then to be transferred to the rotary shaft whereby to cause propulsion of the inertial drive apparatus.

Therefore, a general object of this invention is to provide a rotary inertia drive apparatus that enables a vehicle to navigate using only inertia forces.

Another object of this invention is to provide a rotary inertia drive apparatus, as aforesaid, that is capable of using a force induced by rotary motion of a flyweight rotating or spinning around a spindle shaft to be transferred to a rotary shaft.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is an isometric view of a rotary inertia drive apparatus according to the present invention;

FIG. 2a is a side elevation view of the rotary inertia drive apparatus as in FIG. 1;

FIG. 2b is an end elevation view of the rotary inertia drive apparatus as in FIG. 1;

FIG. 2c is an isolated view on an enlarged scale of a spindle arm illustrating a force acting on the apparatus;

FIG. 2d is an isolated view of a rotary inertia drive apparatus according to an alternative embodiment of the spindle arm as in FIG. 2c; and

FIG. 3 is a perspective view of another alternative embodiment of the present invention, illustrating a pair of rotary inertia drive apparatus arranged so that a need for an exterior guide system is eliminated by neutralizing gyroscopic effects of the rotary components.

### DESCRIPTION OF THE PREFERRED EMBODIMENT

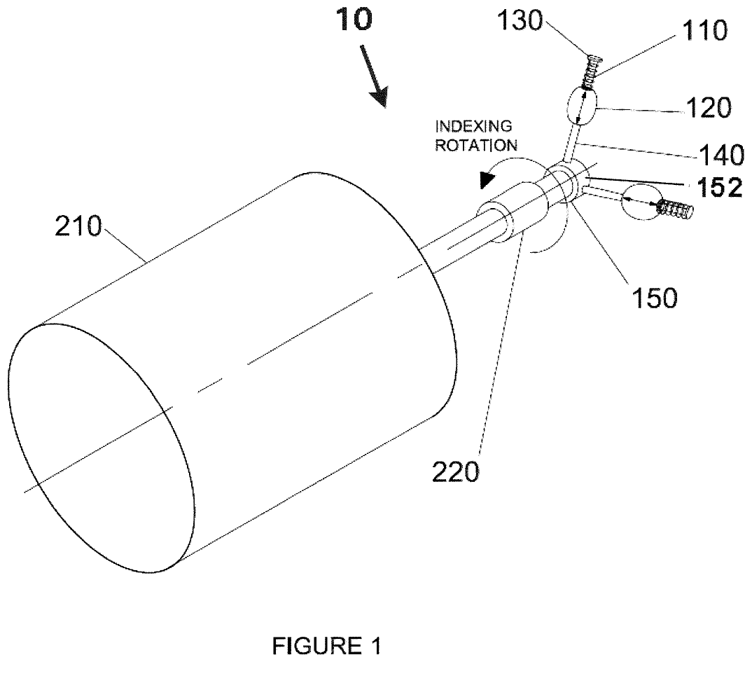

The present invention will now be described by referencing the appended figures. FIG. 1 depicts an isometric view of an inertial drive apparatus 10.

The inertial drive apparatus 10 includes an indexing drive element 210, such as an electric servo motor, to which a driveshaft 160 having a linear configuration is rotated when the indexing drive element 210 is actuated. The driveshaft 160 may be operatively coupled to a rotary shaft 150 via a coupling 220. In some embodiments, of course, the driveshaft and rotor shaft may have a unitary or integrated construction. In any case, the driveshaft and rotary shaft are configured to index at the same speed and at a speed that may accelerate or decelerate as will be described below in greater detail.

As introduced previously, the inertial drive apparatus 10 may include a plurality of spindle shafts 140 although embodiments having fewer or more spindle shafts 140 may also work. Each spindle shaft 140 may include a proximal end that is operatively coupled to a cap or flange 152 which itself is then fixedly coupled to a distal end of the rotary shaft 150 such that each spindle shaft 140 is geometrically normal or perpendicular to the rotary shaft 150. As will be understood more fully later, as a force is induced in respective spindle shafts 140, those forces will be transferred and manifested as a rotary movement of the rotary shaft 150 which results in propulsion of the inertial drive apparatus 10 as a whole.

In an embodiment, a flyweight 120 may be slidably coupled to a respective spindle shaft 140 and is slidable thereon when actuated. Further, a compression spring 110 may be coupled to and longitudinally positioned along a downstream portion of each respective spindle shaft 140. Each compression spring 110 may include a stopper 130 at its outermost tip such that a respective spring may be incrementally compressed as a corresponding flyweight 120 rotates and slides outwardly. It is understood that the collision between a flyweight 120 and stopper 130 causes a tensile force upon the respective spindle shaft 140. When this force is transferred to the rotary shaft, a forward propulsion force is generated whereby the vehicle is moved. By contrast, as a flyweight 120 decelerates, the compression spring 110 will naturally push the flyweight 120 inwardly in the direction of a proximal end of a respective spindle shaft 140. However, there is no stopper in this direction and thus no propulsive force is generated.

Stated another way, each spindle shaft 140 may be coupled to a flyweight 120, said flyweight being configured to slide along the spindle shaft 140. The flyweight 120 is shown as a heavy solid but could also be a contained liquid. There may be two or more spindle shafts placed in equal angular increments. For instance, in a three-shaft system the angular displacement between each spindle shaft 140 would be 120 degrees. The spindle shafts will have a solid connection to the rotary shaft 150. The spindle shafts would be set on an angle anywhere from 1 to 89 degree normal from the rotary shaft 150. The stopper 130 limits the travel of the flyweight 120 outward from the rotary shaft 150. The compression spring 110 is positioned between (i.e., intermediate) the flyweight 120 and the stopper 130.

The rotary shaft 150 is connected to the drive shaft 160 by a coupling 220. The rotary shaft 150 is driven by an indexing drive element 210 which could be a stepper, servo motor, mechanical indexing drive such as a Scottish yoke, or the like.

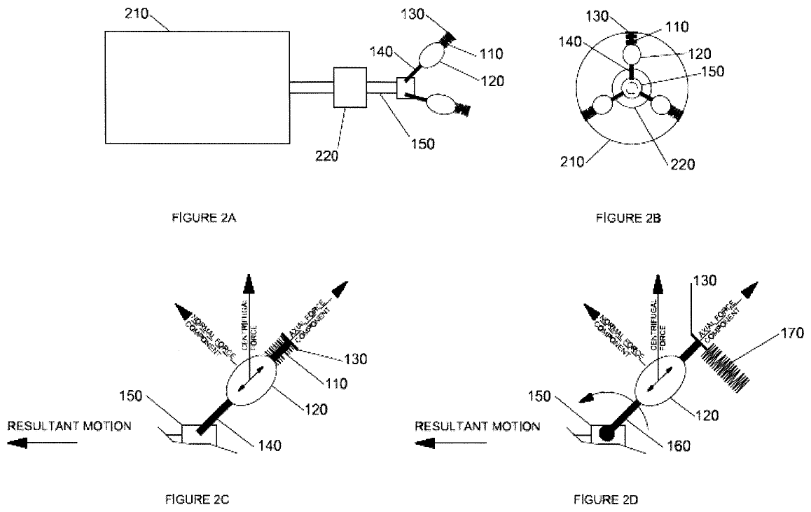

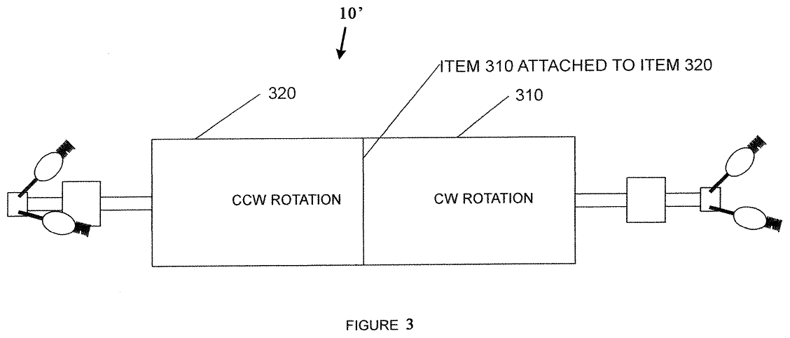

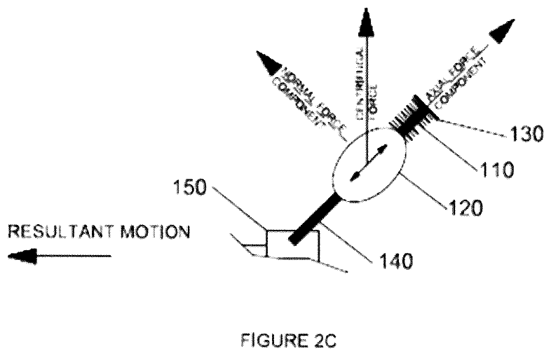

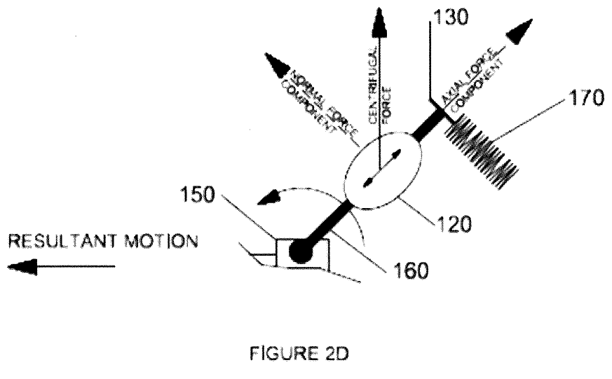

FIG. 2a shows the apparatus with the described components in a side elevation view and FIG. 2b shows them in an end elevation view. FIG. 2c shows a detailed view of the spindle shaft showing the directions of generated forces and motions as is traditional when illustrating indexed vertices.

FIG. 2d shows an alternate configuration with a pivoting spindle shaft 140 contained with an extension spring 170.

A rotary drive apparatus 10′ according to an alternative embodiment includes the same components described previously except as noted below. More particularly, the rotary drive apparatus 10′ illustrated in FIG. 3 may include a tandem configuration of two rotary inertia drive components 310 and 320 arranged so that they would eliminate the need for an exterior guide system by neutralizing the gyroscopic effects of the rotary components. Stated another way, the counterrotating indexing drives would be coupled to one another but would rotate in opposite directions at the same time.

In use, the inertial drive apparatus 10 would index, that is rotate, in an intermittent manner. The index would not have to completely stop but merely accelerate and decelerate. The advantage of stopping and restarting is that it would reduce the gyroscopic effects. As the flyweights are rotated and accelerated the flyweights travel outwardly and away from the center due to centrifugal force and induce a force normal (i.e., perpendicular) to a respective spindle shaft 140. This causes a temporary force which propels the apparatus 10 parallel to the rotating shaft 150. When the shaft decelerates the flyweights 120 travel back down the respective spindle shaft 140 returned by action of the respective compression spring 110. The flyweights 120 are not contained by a stopper on the return and thereby do not create a reversing force. Using a single drive would require an external guidance system or the apparatus 10 would generate negative gyroscopic effects. When two identical apparatus are placed opposite one another on the same rotational axis and rotated in the opposite directions at the same time (as shown in FIG. 3) they will completely cancel out the opposite gyroscopic effects of each other.

Accordingly, any mechanical system in which a mass is temporarily attached to a driven body and then detaches without inducing an opposite force/momentum will create an inertially driven drive.

It is understood that while certain forms of this invention have been illustrated and described, it is not limited thereto except insofar as such limitations are included in the following claims and allowable functional equivalents thereof.

What is claimed is:

1. An inertial drive apparatus comprising:
an indexing drive element;
a driveshaft coupled to the indexing drive element, the driveshaft having a linear configuration that is rotated when the indexing drive element is actuated;
a rotary shaft operatively coupled to the driveshaft via a coupling;
a plurality of spindle shafts, each spindle shaft having a proximal end operatively coupled to the rotary shaft, the plurality of spindle shafts extending perpendicularly away from the rotary shaft; and
a flyweight slidably coupled to each respective spindle shaft, said flyweight being configured to slide along the respective spindle shaft when actuated;
wherein a force is induced in each respective spindle shaft when said flyweight moves slidably outwardly along the respective spindle shaft, said induced force being transferred to and causing said rotary shaft to rotate, whereby to cause propulsion of the inertial drive apparatus.

2. The inertial drive apparatus as in claim 1, further comprising
a compression spring longitudinally positioned along a portion of each said respective spindle shaft, the compression spring positioned adjacent to the flyweight; and
a stopper positioned at an outermost tip of the compression spring, the stopper being configured to limit the sliding motion of the flyweight;
wherein the compression spring is incrementally compressed as the corresponding flyweight rotates and slides outwardly along the respective spindle shaft until a collision with the stopper is detected, and is incrementally expanded as the corresponding flyweight slides inwardly along the respective spindle shaft so as to push the flyweight inwardly as the flyweight decelerates.

3. The inertial drive apparatus as in claim 1, wherein each spindle shaft of said plurality of spindle shafts is displaced at a predetermined angle from an adjacent spindle shaft.

4. The inertial drive apparatus as in claim 1, wherein said coupling causes the rotary shaft to have a unitary construction with the driveshaft.

5. The inertial drive apparatus as in claim 2, wherein the compression spring is (1) incrementally compressed and the flyweight moves outwardly along the spindle shaft as the flyweight rotates in a first direction indicative of an acceleration and is (2) incrementally expanded and the flyweight moves inwardly along the spindle shaft as the flyweight rotates in a second direction indicative of a deceleration.

6. The apparatus as in claim 1, wherein the indexing drive element is an electric servo motor.

7. The apparatus of claim 1, wherein the number of spindle shafts is variable.

8. The apparatus of claim 2, wherein the flyweight and compression spring are configured such that the stopper limits the maximum outward sliding motion of the flyweight along the spindle shaft.

9. A method of operating an inertial drive apparatus, the method comprising:
actuating an indexing drive element to index a driveshaft, the driveshaft having a linear configuration;
transferring rotation from the driveshaft to a rotary shaft via a coupling that operatively connects said driveshaft to said rotary shaft;
rotating a plurality of spindle shafts operatively coupled to the rotary shaft, each spindle shaft extending perpendicularly and outwardly from the rotary shaft;
sliding a flyweight along each respective spindle shaft in response to the rotation of the rotary shaft; and
positioning a compression spring longitudinally along each respective spindle shaft adjacent and downstream from each respective flyweight;
said respective flyweight compressing a respective compression spring when the corresponding flyweight moves outwardly along a respective spindle shaft.

10. The method as in claim 9, further comprising:
stopping the outward movement of a respective flyweight using a stopper positioned at an outermost tip of each respective compression spring; and
said respective flyweight allowing expansion of said respective compression spring when the corresponding flyweight moves inwardly along said respective spindle shaft;
wherein the compression spring pushes the flyweight inwardly along the spindle shaft as the flyweight decelerates.

11. The method as in claim 10, wherein:
said respective flyweight moves outwardly along said respective spindle shaft when said respective flyweight accelerates; and
said respective flyweight moves inwardly along said respective spindle shaft when said respective flyweight decelerates.

12. The method as in claim 9, further comprising incrementally compressing a respective compression spring as a respective flyweight accelerates and slides outwardly along a respective spindle shaft.

13. The method as in claim 9, wherein actuating the indexing drive element includes operating an electric servo motor to rotate the driveshaft.

14. The method as in claim 9, wherein said plurality of spindle shafts includes a predetermined number of spindle shafts equally and angularly spaced apart from one another, actuation of said plurality of flyweights causing said plurality of spindle shaft to impart a force upon said rotary shaft to thereby cause navigation of the inertia drive apparatus.
